(19) United States
(12) Patent Application Publication
(10) Pub. No.: US 2006/0055639 A1
(43) Pub. Date: Mar. 16, 2006

(54) Display device, on-vehicle display device, electronic apparatus, and display method

(75) Inventor: Tadashi Yamada, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION., Tokyo (JP)

(21) Appl. No.: 11/210,894

(22) Filed: Aug. 25, 2005

(30) Foreign Application Priority Data
Sep. 13, 2004 (JP) 2004-265649
Sep. 13, 2004 (JP) 2004-265650

(51) Int. Cl. G09G 3/30

(52) U.S. Cl. 345/77

(57) ABSTRACT

Aspects of the invention can provide a display device having at least two sets of chromatic balance coordinates which define reference colors for a display color.

This application claims the benefit of Japanese Application No. 2004-265649 filed Sep. 13, 2004, and No. 2004-265650 filed on Sep. 13, 2004, which are hereby incorporated by reference herein in their entirety.

### BACKGROUND

Aspects of the invention can relate to a display device, an on-vehicle display device, an electronic apparatus, and a display method.

Organic electroluminescent (EL) display devices are expected as next-generation display devices. Related art organic EL display devices can include a plurality of organic EL elements arranged on one surface of a substrate, each element having a luminescent layer provided between upper and lower electrodes, and can display a desired image by separately controlling driving of the organic EL elements. Although this related art organic EL device can emit light at a high luminance in the beginning of driving, it has a problem in that continuous emission of light gradually decreases the efficiency of the device, thus causing a decrease in luminance. Accordingly, an organic EL device has been proposed in which alternating-current (AC) driving is used to drive organic EL elements so that their lives can be extended. See, for example, Japanese Unexamined Patent Application Publication No. 8-180972. Further, an organic EL device which employs sinusoidal wave AC driving has been proposed. See, for example, Japanese Unexamined Patent Application Publication No. 2000-30862.

In addition, recently, a related art organic EL device capable of displaying a color image has been described. In order for an organic EL device to display a color image, it is common that one pixel is formed by three organic EL elements, having emission colors respectively corresponding to red, green, and blue. Luminescent layers corresponding to the above colors have different luminances of emission. Thus, to establish white balance of display, a technique that sets the organic EL elements to have different emission areas has been employed. See, for example, Japanese Unexamined Patent Application Publication No. 10-39791.

According to each of the technologies described in the above patent publications, it seems that a tentative solution to each problem can be provided. However, although, in the technology described in Japanese Unexamined Patent Application Publication No. 8-180972, a period in which the organic EL device can emit light can be extended and display at a relatively high luminance is possible, a problem occurs in that, since the above effects cause an increase in the peak value of a reverse bias voltage, breakdown of the organic EL elements easily occurs due to the reverse bias voltage.

In the technology described in Japanese Unexamined Patent Application Publication No. 2000-30862, by providing a limit on a forward current or a reverse bias voltage, breakdown of the organic EL elements is prevented. However, since the waveform of sinusoidal waves is used as an AC driving waveform, the use of an integrated circuit makes it very difficult to apply a driving waveform that matches display of large volumes of data. In addition, in the technologies described in Japanese Unexamined Patent Application Publication Nos. 8-180972 and 2000-30862, in a driving mode, complete AC electric fields (forward and reverse electric fields that are equivalent to each other in peak value and total quantity of electric charge) cannot be applied. Thus, there is a possibility that polarization of electric charge occurs in the elements in the driving mode, thus causing decomposition of electrodes, charge injection and transport layers, and luminescent layers. Therefore, it is extremely difficult to ensure a sufficient life for the display device.

Although the technology described in Japanese Unexamined Patent Application Publication No. 10-39791 can establish white balance in the beginning of driving, it has a problem in that the luminance balance of the organic EL elements changes in the long term to break the white balance with elapse of time because, depending on different colors, the organic EL elements have not only different emission characteristics but also different emission lives. Accordingly, when, in a display device of the related art, light-emitting elements corresponding to three primary colors have different emission lives, a display area that is white when the display device is produced changes to a color such as yellow-green. Therefore, when an instrument panel in which a vehicle speedometer or the like is provided is manufactured by using the display device of the related art, a problem occurs in that the speedometer, which is white when the vehicle is purchased, changes to yellow-green after several years.

In addition, regarding the display device of the related art, in a case in which the integration value of a display luminance of a particular color is extremely greater than the integration values of other colors, specifically, such as a case in which only one of three-primary-color pixel components is most frequently used, color shifting (change in display color) and sticking may occur with elapse of time. In addition, in the display device of the related art, a color (white), obtained such that the three-primary-color pixel components emit light components at high luminances, has a peak luminance. Accordingly, the display device of the related art has a problem in that the peak luminance cannot be set for a desired color other than white.

### SUMMARY

Aspects of the invention can provide a display device, an on-vehicle display device, an electronic apparatus, and a display method that display a desired color for a long period.

In addition, an aspect of the invention can provide a display device which displays a desired color by combining fundamental colors such as red, green, and blue, and in which, even if long-term deterioration characteristics of light-emitting units for emitting the colors differ depending on the colors, the desired color can be displayed at a desired luminance for a long period, an on-vehicle display device and electronic apparatus to which the display device is applied, and a display method therefor.

In addition, an aspect of the invention can be that it provides a display device, an on-vehicle display device, an electronic apparatus, and a display method that prevent color shifting and sticking from occurring for a long time.

Furthermore, an aspect of the invention is that it provides a display device, an on-vehicle display device, an electronic apparatus, and a display method which have an extended display device life and in which good color display is obtained by suppressing a change in long-term chromatic balance.

A display device according to a first aspect of the invention can have at least two sets of chromatic balance coordinates which define reference colors for a display color. The first aspect of the invention can be suitable for a case in which, in a display device for displaying a desired color by combining fundamental colors such as red, green, and blue, long-term deterioration characteristics of light-emitting units for emitting primary colors differ depending on the colors. In this case, according to the first aspect of the invention, by setting one of plural sets of chromatic balance coordinates to be positioned so as to be shifted from the coordinates representing white, the amount (such as a luminance, quantity of emission, or quantity of a driving current) of utilization of a light-emitting unit (for example, for blue) that has relatively large long-term deterioration can be reduced. In other words, the luminance of the blue light-emitting unit is set to be lower than the luminances of red and green light-emitting units, and the color of light obtained by combining light components from the light-emitting units can be used as the color of the set of chromatic balance coordinates at the shifted position.

According to the first aspect of the invention, by displaying a color represented by the set of chromatic balance coordinates at the shifted position, the lives of the light-emitting units corresponding to the colors can be equalized, and a desired color can be displayed for a long period, whereby an extended display-device life can be achieved. In addition, according to the first aspect of the invention, when it is necessary to particularly diversify color representations, such as display of a natural object, another set of chromatic balance coordinates among the plural sets of chromatic balance coordinates can be used as a set of coordinates representing white for establishing white balance or the like, whereby a high-definition color image can be displayed.

In addition, it is preferable that, in the display device according to the first aspect of the invention, one of the at least two sets of chromatic balance coordinates define white. According to the first aspect of the invention, by establishing white balance, for example, at the set of chromatic balance coordinates (first set of chromatic balance coordinates) defining white, a high-definition color image can be displayed. When it is not necessary to display a high-definition color image, by displaying a color image by using another set (other than the first set) of chromatic balance coordinates, an extended display-device life can be achieved.

In addition, it can be preferable that, in the display device according to the first aspect of the invention, one of the at least two sets of chromatic balance coordinates represent a first set of coordinates (0.33±0.02, 0.33±0.02) in a chromaticity diagram having (x, y) space, and another set of chromatic balance coordinates represent a set of coordinates other than the first set of coordinates in the chromaticity diagram.

According to the first aspect of the invention, since the first set of coordinates represents white, by using the first set of coordinates as a reference point for white balance, a high-definition color image having a broad color representation range can be displayed. In addition, by displaying a desired color by using a set of coordinates other than the first set of coordinates in the chromaticity diagram, an extended display-device life can be achieved. In other words, by using the first set of coordinates, a high-definition color image can be displayed using all the display-device capability of color representation while establishing white balance. In addition, with a set of coordinates other than the first set of coordinates, a color can be displayed by reducing the luminance or the like of a light-emitting unit (for example, for blue) having relatively large long-term deterioration, whereby the life of each light-emitting unit for each color can be equalized, thus achieving an extended display-device life.

In addition, it can be preferable that, the display device according to the first aspect of the invention further include a coordinate-switching control unit that sets the utilization factor of chromatic balance coordinates defining white to be less than the utilization factor of chromatic balance coordinates defining another color.

According to the first aspect of the invention, by using the coordinate-switching control unit, the utilization factor of the light-emitting unit (for example, for blue) having relatively large long-term deterioration can be reduced. Here, the utilization factor includes not only an emission time but also a ratio concerning a luminance (the brightness of a surface emitting light which is seen by human eyes), a luminous intensity (the brightness of a point source of light), the quantity of a driving current, or the like, and is a ratio concerning a factor which influences long-term deterioration characteristics of emission.

In addition, it is preferable that the display device according to the first aspect of the invention have pixels, each pixel including at least two pixel components having different optical spectrum characteristics, and the at least two sets of chromatic balance coordinates define reference colors for a display color on the pixel.

According to the first aspect of the invention, the pixel can display various colors. Therefore, by disposing a plurality of pixels in a predetermined area, the predetermined area can display a color image. In addition, according to the first aspect of the invention, even if pixel components of one pixel have different long-term deterioration characteristics, the utilization factor of one pixel component (for example, a blue pixel component), which has a bad long-term deterioration characteristic, can be reduced, thus achieving an extended display-device life.

In addition, it can be preferable that, in the display device according to the first aspect of the invention, the pixel include a first pixel component for emitting a light component having a first peak wavelength (R), a second pixel component for emitting a light component having a second peak wavelength (G), and a third pixel component for emitting a light component having a third peak wavelength (B), the at least two sets of chromatic balance coordinates have a first set of chromatic balance coordinates and a second set of chromatic balance coordinates, the first set of chromatic balance coordinates represents white, and the second set of chromatic balance coordinates represent a color other than white.

According to the first aspect of the invention, for example, the first pixel displays red, the second pixel displays green, and the third pixel displays blue, whereby a color image can be displayed. In addition, according to the first aspect of the invention, the first set of chromatic balance coordinates can be used to display a high-definition color image having a broad color representation range, and the second set of chromatic balance coordinates is used to achieve an extended display-device life.

In addition, it is preferable that, in the display device according to the first aspect of the invention, the second set of chromatic balance coordinates represent a color obtained by mixing, at a predetermined ratio, the light components emitted by the first, second, and third pixel components, and represent a color obtained by mixing the light components which are emitted by the first, second, and third pixel components, with the ratio of the light component of one pixel component set to be greater than the light components of the other pixel components, the one pixel component having the least long-term emission-luminance deterioration among the first, second, and third pixel components.

According to the first aspect of the invention, by using the second set of chromatic balance coordinates, various colors can be displayed, and the ratio of a pixel component, among the first, second, and third pixel components, which has the largest long-term deterioration in emission luminance can be decreased. Therefore, according to the first aspect of the invention, by using the second set of chromatic balance coordinates, long-term deterioration in display characteristic can be suppressed while displaying a color image.

In addition, it is preferable that the display device according to the first aspect of the invention further include a display color control unit which controls the display color by using the first set of chromatic balance coordinates when a natural image is displayed, and which controls the display color by using the second set of chromatic balance coordinates when a measuring instrument image indicating the result of measurement by a measuring instrument is displayed.

According to the first aspect of the invention, for example, when a natural image, such as a scene or a person, input through a video camera is displayed, a high-definition color image can be displayed by using the first set of chromatic balance coordinates defining white. In addition, when it is necessary to display a measuring instrument image showing the result of measurement by a measuring instrument, long-term deterioration in display characteristic can be suppressed by using the second set of chromatic balance coordinates. In other words, when the second set of chromatic balance coordinates is used, among the first, second, and third pixel components, the ratio of a pixel component having the largest long-term deterioration in emission luminance can be decreased, thus suppressing long-term deterioration in display characteristic.

To achieve the advantages of the invention, an on-vehicle display device according to a second aspect of the invention can have the configuration of the above display device in a form installable in a vehicle. In addition, it is preferable that the on-vehicle display device be provided on an instrument panel in the vicinity of a driver's seat in the vehicle.

According to the second aspect of the invention, for example, when a speed or the like is displayed on the instrument panel of the vehicle, by using the second set of chromatic balance coordinates, an extended display-device life can be achieved, with a color display range narrowed. In addition, in the case of displaying an image behind the vehicle by the instrument panel when the vehicle is backward driven, by using the first set of chromatic balance coordinates, a high-definition color image having a color representation range can be displayed. Therefore, according to the second aspect of the invention, information in various forms can be accurately displayed in colors for the driver of the vehicle, and an on-vehicle display device having a long product life can be provided.

To achieve the advantages of the invention, an electronic apparatus according to a third aspect of the invention can include the above display device. According to the third aspect of the invention, a color image can be displayed and a desired color can be displayed for a long period. In addition, an electronic apparatus including a long life display device can be provided.

To achieve the advantages of the invention, in a display method according to a fourth aspect of the invention, at least two sets of chromatic balance coordinates which define reference colors for a display color are set. According to the fourth aspect of the invention, for example, when white is used as chromatic balance coordinates, by extending a color representation range tip to the full capability of the display device, a high-definition color image can be displayed. In addition, when a color other than white is used as chromatic balance coordinates, by decreasing the luminance or the like of a light-emitting unit (for example, for blue) having relatively large long-term deterioration, the lives of light-emitting units for colors can be equalized, thus achieving an extended display-device life.

In addition, it is preferable that, in the display method according to the fourth aspect of the invention, one of the at least two sets of chromatic balance coordinates define white, and the utilization factor of the set of chromatic balance coordinates which defines white be less than the utilization factor of a different set of chromatic balance coordinates. According to the fourth aspect of the invention, a high-definition color image can be displayed, for example, by establishing white balance by using the chromatic balance coordinates defining white. In addition, according to the fourth aspect of the invention, by displaying a color image by using another set of chromatic balance coordinates, the operational lives of light-emitting units for colors can be equalized, thus achieving an extended display-device life.

In addition, it is preferable that, in the display method according to the fourth aspect of the invention, an image be displayed by using pixels, each pixel including at least two pixel components having different optical spectrum characteristics, and the different set of chromatic balance coordinates represent a color obtained by mixing, at a predetermined ratio, light components emitted by the pixel components of the pixel, and represent a color obtained by mixing the light components emitted by the pixel components, with the ratio of the light component of one pixel component set to be greater than the light components of the other pixel components, the one pixel component having the least the long-term emission-luminance deterioration among the pixel components.

According to the fourth aspect of the invention, among the pixel components of the pixel, the ratio of a light component from a pixel component having the largest long-term deterioration in emission luminance can be decreased. Therefore, in the fourth aspect of the invention, since a pixel component having larger long-term deterioration emits a light component at a low luminance, the long-term deterioration of each pixel component can be equalized, thus suppressing long-term deterioration in display characteristic.

In addition, it is preferable that, in the display method according to the fourth aspect of the invention, when the result of measurement by a measuring instrument is displayed, the different set of chromatic balance coordinates be used for display, and, when information other than the result of the measurement is displayed, the set of chromatic balance coordinates defining white be used for display.

According to the fourth aspect of the invention, when a measuring instrument image indicating the result of measurement is displayed, by using the different set of chromatic balance coordinates to narrow a color representation range, the long-term deterioration of each pixel can be equalized, thus suppressing long-term deterioration in display characteristic. In addition, for example, when a natural image, such as an image input by a video camera, is displayed, by expanding a color representation range by using the chromatic balance coordinates defining white, a high-definition color image can be displayed.

An exemplary display device according to a fifth aspect of the invention can include a color control unit which has at least two sets of chromatic balance coordinates defining reference colors for a display color on a display portion, and which controls the display color on the display portion by using one of the at least two sets of chromatic balance coordinates, and a luminance control unit which controls the luminance of the display portion.

The fifth aspect of the invention can be suitable for a case in which, in a display device for displaying a desired color by mixing fundamental colors such as red, green, and blue, the long-term deterioration characteristics of light-emitting units (pixel components) that emit the primary colors differ depending on the colors. In this case, according to the fifth aspect of the invention, by setting one of plural sets of chromatic balance coordinates to be positioned so as to be shifted from the coordinates representing white, the amount (such as a luminance, quantity of emission, or quantity of a driving current) of utilization of a light-emitting unit (for example, for blue) that has relatively large long-term deterioration can be reduced. In other words, in general, the smaller the luminance of each pixel component, the less the long-term deterioration of the pixel component.

Accordingly, the luminance of the blue light-emitting unit can be set to be lower than the luminances of red and green light-emitting units, and the color of light obtained by combining light components from the light-emitting units can be used as the color of the set of chromatic balance coordinates at the shifted position. Therefore, according to the fifth aspect of the invention, by displaying a color represented by the set of chromatic balance coordinates at the shifted position, the lives of the light-emitting units corresponding to the colors can be equalized, and a desired color can be displayed for a long period, whereby an extended display-device life can be achieved. In addition, according to the fifth aspect of the invention, when it is necessary to particularly diversify color representations such as display of a natural object, another set of chromatic balance coordinates among the plural sets of chromatic balance coordinates is used as a set of coordinates representing white for establishing white balance or the like, whereby a high-definition color image can be displayed.

In addition, it is preferable that, in the display device according to the fifth aspect of the invention, the luminance control unit switch the luminance in association with switching of the at least two sets of chromatic balance coordinates used in the color control unit.

It is preferable that, in the display device according to the fifth aspect of the invention, the color control unit switch to use a different set of chromatic balance coordinates in association with a luminance obtained by switching in the luminance control unit.

According to the aspect of the invention, the switching of the sets of chromatic balance coordinates and the switching of luminances can be associated with each other. For example, when a set of chromatic balance coordinates having a broad color reproduction range is used, the luminance of each pixel component is decreased. Therefore, a color image having a broad color reproduction range can be displayed while equalizing the long-term deterioration of pixel components. In addition, according to the fifth aspect of the invention, when displaying a color corresponding to a pixel component having a long life, a clear image can be displayed at a high luminance.

In addition, it is preferable that, in the display device according to the fifth aspect of the invention, the at least two sets of chromatic balance coordinates include a first set of chromatic balance coordinates defining white and a second set of chromatic balance coordinates defining one of colors other than white.

According to the fifth aspect of the invention, for example, when white balance is established by using the first set of chromatic balance coordinates defining white, a high-definition color image can be displayed. When it is not necessary to display a high-definition color image, by displaying a color image by using the second set of chromatic balance coordinates, an extended display-device life can be achieved while performing high luminance display.

In addition, it is preferable that, in the display device according to the fifth aspect of the invention, the color control unit use the first set of chromatic balance coordinates when a luminance obtained by switching in the luminance control unit is less than a predetermined threshold value, and use the second set of chromatic balance coordinates when the luminance is greater than the predetermined threshold value.

According to the fifth aspect of the invention, for example, when the luminance is relatively small, by using the first set of chromatic balance coordinates, a high-definition color image having a broad color reproduction range can be displayed while achieving an extended life. In addition, when the luminance is relatively larger, by using the second set of chromatic balance coordinates, a desired color can be displayed at a high luminance while achieving an extended life.

In addition, it is preferable that the display device according to the fifth aspect of the invention have pixels, each pixel including at least two pixel components having different optical spectrum characteristics, the at least two sets of chromatic balance coordinates define reference colors for a color displayed on the pixels, the pixel includes a first pixel component for emitting a light component having a first peak wavelength (R), a second pixel component for emitting a light component having a second peak wavelength (G), and a third pixel component for emitting a light component having a third peak wavelength (B), the second set of chromatic balance coordinates represents a color obtained by mixing, at a predetermined ratio, the light components emitted by the first, second, third pixel components, and represents a color obtained by mixing the light components emitted by the first, second, third pixel components, with the ratio of the light component of one pixel component set to be greater than the light components of the other pixel components, the one pixel component having the least long-term emission-luminance deterioration among the first, second, third pixel components.

According to the fifth aspect of the invention, for example, the first pixel component displays red, the second pixel displays green, and the third pixel component displays blue, whereby each pixel can display various colors to enable display of a color image.

In addition, according to the fifth aspect of the invention, even if the long-term deterioration characteristics of pixel components of one pixel differ, the utilization factor (such as the product of the luminance and an emission time) of one pixel component (for example, a blue pixel component), which has a bad long-term deterioration characteristic, can be reduced, thus achieving an extended display-device life. According to the fifth aspect of the invention, by using the first set of chromatic balance coordinates, a high-definition color image having a broad color representation range can be displayed, and, by using the second set of chromatic balance coordinates, an extended display-device life can be achieved while performing high luminance display.

In addition, it is preferable that the display device according to the fifth aspect of the invention further include an illumination detecting unit for detecting an illumination in the vicinity of the display device, and the luminance control unit switch the luminance based on the detected illumination.

Furthermore, the display device according to the fifth aspect of the invention has a function of setting the luminance to be greater than a target luminance when the illumination is greater than a predetermined reference value, and setting the luminance to be less than the target luminance when the illumination is less than the predetermined reference value.

According to the fifth aspect of the invention, for example, an image is displayed at a low luminance in a case (the inside of the vehicle in nighttime) in which it is dark around or near a display portion. In this case, since it is dark around the display portion, clear display is possible even at the low luminance. In addition, in a case (the inside of the vehicle in daytime) in which it is around or near the display portion, an image is displayed at a relatively high luminance. In this case, for example, a speedometer or the like can be clearly displayed in desired color.

In addition, it is preferable that, in the display device according to the fifth aspect of the invention, the luminance control unit switch the luminance in association with a display form used in the display portion. Here, it is preferable that the display form be one of a natural image representation, a representation of an image other than a natural image, an analog representation of the result of measurement, and a digital representation of the result of measurement.

It is preferable that, in the display device according to the fifth aspect of the invention, the color control unit have a function of using the first set of chromatic balance coordinates to control a display color when a natural image is displayed on the display portion, and using the second set of chromatic balance coordinates to control the display color when an image other than the natural image is displayed on the display portion, and the luminance control unit has a function of setting the luminance to be less than a target value when the natural image is displayed on the display portion, and setting the luminance to be greater than the target value when an image other than the natural image is displayed on the display portion.

According to the fifth aspect of the invention, for example, when a natural image, such as a person or scene image, input by a video camera, a high-definition color image can be displayed by using the first set of chromatic balance coordinates representing white. In this case, low luminance display can achieve an extended life. In addition, according to the fifth aspect of the invention, when information, such as a speedometer, other than a natural image, is displayed, the second set of chromatic balance coordinates is used, and a clear image can be displayed at a high luminance while achieving an extended life.

In an exemplary on-vehicle display device according to a sixth aspect of the invention, the configuration of the above display device is provided in a vehicle. In addition, it is preferable that the on-vehicle display device according to the sixth aspect of the invention be mounted on an instrument panel installed around a driver's seat in the vehicle.

According to the sixth aspect of the invention, for example, when a speed or the like is displayed by the instrument panel of the vehicle, by using the second set of chromatic balance coordinates, an extended display-device life can be achieved, with a color reproduction range narrowed. At this time, high luminance display enables clear display of the speed even in daytime. In addition, in a case in which an image behind the vehicle is displayed on the instrument panel when the vehicle is backward driven, by using the first set of chromatic balance coordinates, a high-definition color image having a broad color representation range can be displayed. Therefore, according to the sixth aspect of the invention, information of various types can be accurately displayed in colors for the driver of the vehicle, and an on-vehicle display device having a long product life can be provided.

To achieve the advantages, an electronic apparatus according to a seventh aspect of the invention includes the display device. According to the seventh aspect of the invention, an electronic apparatus including a long life display device which can display a color image having a broad color reproduction range and which can display a target color at a target luminance over a long period can be provided. Therefore, according to the seventh aspect of the invention, an electronic apparatus including a display device that can prevent color shifting and sticking from occurring can be provided.

To achieve the advantages, a display method according to an eighth aspect of the invention includes setting at least two sets of chromatic balance coordinates defining reference colors for a display color on a display portion, switching the at least two sets of chromatic balance coordinates to control the display color on the display portion by using one set of chromatic balance coordinates, variably controlling the luminance of the display portion, and controlling the switching of the at least two sets of chromatic balance coordinates and the variably controlling of the luminance so that the switching of the sets of chromatic balance coordinates and the variably controlling of the luminance are associated with each other.

According to the eighth aspect of the invention, when white is used as chromatic balance coordinates, by extending a color representation range up to the full capability of the display device, a high-definition color image can be displayed. At this time, by relatively decreasing the display luminance, an extended display-device life can be achieved. In addition, when a color other white is used as the chromatic balance coordinates, by decreasing the luminance of a pixel component (for example, for blue) having relatively large deterioration, and increasing the luminance of a pixel component for a color having long-term deterioration, an extended display-device life can be achieved while displaying an image at a high luminance.

Furthermore, it is preferable that, in the display method according to the eighth aspect of the invention, the at least two sets of chromatic balance coordinates include a first set of chromatic balance coordinates defining white and a second set of chromatic balance coordinates defining one of colors other than white, and, when the luminance needs to be less than a predetermined threshold value, the first set of chromatic balance coordinates be used, and when the luminance needs to be greater than the predetermined threshold value, the second set of chromatic balance coordinates be used.

According to the eighth aspect of the invention, for example, by using the first set of chromatic balance coordinates to display an image while relatively decreasing the luminance, a high-definition color image having a color reproduction range can be displayed while achieving an extended display-device life. In addition, by using the second set of chromatic balance coordinates to display an image while relatively increasing the luminance, a desired color can be displayed while achieving an extended display-device life.

In addition, it is preferable that, in the display method according to the eighth aspect of the invention, an image be displayed by using pixels, each pixel including at least two pixel components having different optical spectrum characteristics, and the second set of chromatic balance coordinates represent a color obtained by mixing, at a predetermined ratio, light components emitted by the pixel components of the pixel, and represents a color obtained by mixing the light components emitted by the pixel components, with the ratio of the light component of one pixel component set to be greater than the light components of the other pixel components, the one pixel component having the least long-term emission-luminance deterioration among the pixel components.

According to the eighth aspect of the invention, for example, the first pixel component displays red, the second pixel displays green, and the third pixel component displays blue, whereby each pixel can display various colors to enable display of a color image.

In addition, according to the eighth aspect of the invention, even if the long-term deterioration characteristics of pixel components of one pixel differ, the utilization factor (such as the product of the luminance and an emission time) of one pixel component (for example, a blue pixel component), which has a bad long-term deterioration characteristic, can be reduced, thus achieving an extended display-device life. According to the eighth aspect of the invention, by using the first set of chromatic balance coordinates, a high-definition color image having a broad color representation range can be displayed, and, by using the second set of chromatic balance coordinates, an extended display-device life can be achieved while performing high luminance display.

Furthermore, it is preferable that, in the display method according to the eighth aspect of the invention, an illumination in the vicinity of the display portion be detected, and the luminance be set to be greater than a target luminance when the illumination is greater than a predetermined reference value, and is set to be less than the target luminance when the illumination is less than the predetermined reference value.

According to the eighth aspect of the invention, by displaying an image at a low luminance in a case (the inside of the vehicle in nighttime) in which it is dark around or near a display portion, an extended display-device life can be achieved while clearly displaying the image. In addition, by displaying an image at a relatively high luminance in a case (the inside of the vehicle in daytime) in which it is around or near the display portion, a speedometer or the like can be clearly displayed.

Furthermore, it is preferable that, in the display method according to the eighth aspect of the invention, when the result of measurement by a measuring instrument is displayed, the second set of chromatic balance coordinates be used for display, and, when information other than the result of the measurement is displayed for display, the first set of chromatic balance coordinates be used for display.

According to the eighth aspect of the invention, when the result of measurement is displayed, by using the second set of chromatic balance coordinates to narrow a color representation range, the long-term deterioration of each pixel component can be equalized, thus suppressing the long-term deterioration in display characteristic, with the image displayed at a high luminance. In addition, for example, when a natural image is displayed, by broadening the color representation range by using the first set of chromatic balance coordinates, a high-definition color image can be displayed.

### BRIEF DESCRIPTION OF THE DRAWINGS

The invention will be described with reference to the accompanying drawings, wherein like numbers reference like elements, and wherein:

FIG. 1 is a graph showing the basic configuration of a display device according to an exemplary embodiment of the invention;

FIG. 2 is a graph showing long-term deterioration characteristics of pixel components in the display device;

FIG. 3 schematically shows an example of an on-vehicle instrument panel;

FIG. 4 schematically shows an example of the on-vehicle instrument panel;

FIG. 5 is a graph showing a change in luminance of each pixel component when white is continuously displayed;

FIG. 6 is a graph showing a change in display color when white is continuously displayed;

FIG. 7 is a graph showing a change in luminance of each pixel component when a color in a second set of chromatic balance coordinates is displayed;

FIG. 8 is a graph showing a change in display color when a color in a second set of chromatic balance coordinates is displayed;

FIG. 9 is a graph showing an long-term deterioration characteristic of a blue pixel component in the case of different luminances;

FIG. 10 is a graph showing an long-term deterioration characteristic of a blue pixel component in the case of different luminances;

FIG. 11 shows a specific example of the configuration of the display device according to the exemplary embodiment of the invention;

FIG. 12 is a specific circuit diagram of a driver circuit and organic EL panel of the display device;

FIG. 13 is a circuit diagram showing the internal configuration of a pixel component circuit in the display device;

FIG. 14 is a timing chart showing the normal operation of the pixel component circuit;

FIG. 15 is a circuit diagram showing the internal configuration of a single-line driver in the display device;

FIGS. 16A to 16C are perspective views of electronic apparatuses according to an exemplary embodiment of the invention;

FIG. 17 is an illustration of an example of the basic operation of a display device according to a second exemplary embodiment of the invention; and

FIG. 18 is a block diagram showing a specific example of the display device according to the second exemplary embodiment of the invention.

### DETAILED DESCRIPTION OF EMBODIMENT

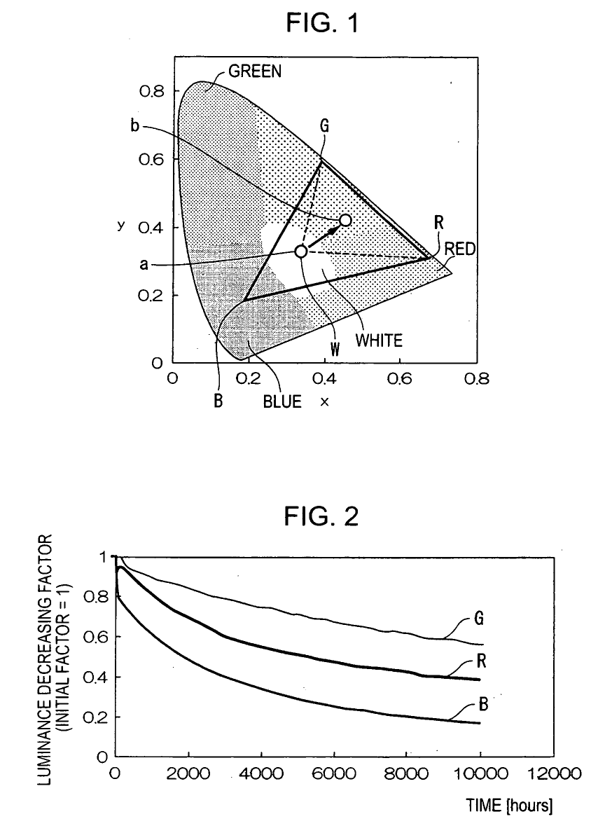

A display device according to a first exemplary embodiment of the invention will be described below with reference to the accompanying drawings. FIG. 1 illustrates the basic configuration of the display device according to the first exemplary embodiment. FIG. 1 is a chromaticity diagram having (x, y) space defined by an x-axis and a y-axis.

The display device according to the first exemplary embodiment has a plurality of pixels in matrix form, each pixel including a set of a first pixel component for emitting light having a first peak wavelength corresponding to red (R), a second pixel component for emitting light having a second peak wavelength corresponding to green (G), and a third pixel component for emitting light having a third peak wavelength corresponding to blue (B).

The first pixel component emits light of red defined by point R in the chromaticity diagram. Point R is, for example, coordinates (0.66, 0.33) in the chromaticity diagram. The second pixel component emits light of green defined by point G in the chromaticity diagram. Point G is, for example, coordinates (0.41, 0.58) in the chromaticity diagram. The third pixel component emits light of blue defined by point B in the chromaticity diagram. Point B is, for example, coordinates (0.15, 0.26) in the chromaticity diagram. The following Table 1 shows sets of coordinates in the chromaticity diagram of luminescent colors of the first to third pixel components.

TABLE 1

| Chromaticity | | | |
|---|---|---|---|
| Coordinates | R | G | B |
| X | 0.66 | 0.41 | 0.15 |
| Y | 0.33 | 0.58 | 0.26 |

For each pixel, the luminescent colors of the first to third pixel components are combined. This enables the display device to display colors in the inside region of the triangle having points R, G, and B as vertices. In other words, by changing a mixing ratio (luminance ratio) of the first to third pixel components, various colors can be displayed. For example, by setting the luminance of the first (R) pixel component to be larger and setting the luminances of the second (G) and third (B) pixel components to be smaller, red can be displayed. By setting the luminance of the second (G) pixel component to be larger and setting the luminances of the first (R) and third (B) pixel components to be smaller, greed can be displayed. By setting the luminance of the third (B) pixel component to be larger and setting the first (R) and second (G) pixel components to be smaller, blue can be displayed.

In addition, to display white by the display device, the luminances of the first (R), second (G), and third (B) pixel components are set to be approximately equalized. To display accurate white (pure white), the luminance ratio of the first (R), second (G), and third (B) pixel components is set to (0.2:0.53:0.27). This pure white is defined by the coordinates (0.33, 0.33) of point “a” in the chromaticity diagram. This point “a” indicates a first set of chromatic balance coordinates which serves as a reference point for displaying pure white (reference color) by the display device.

The display device according to the first exemplary embodiment has a second set of chromatic balance coordinates defined differently from the first set of chromatic balance coordinates. The second set of chromatic balance coordinates serves as a reference point for defining a reference color of the display device which differs from the color represented by the first set of chromatic balance coordinates: The second set of chromatic balance coordinates is obtained by shifting the first set of chromatic balance coordinates (defining pure white) in the direction of a long life color represented by the first (R), second (G), third (B) pixel components. In the display device, by way of example, the blue of the third (B) pixel component has a short life. Accordingly, in the display device, point “b”, obtained by shifting point “a” as the first set of chromatic balance coordinates in the direction of the red of the first (R) pixel component and the green of the second (G) pixel component, is used as the second set of chromatic balance coordinates.

Since the life of the blue of the third (B) pixel component is short, the second set of chromatic balance coordinates in the first embodiment are set inside a triangle (indicated by the broken line) having, as vertices, point R of the first pixel component representing red, and point G of the second pixel component representing green. Based on frequencies of use of the first (R) and second (G) pixel components or on a user's preference in accordance with a usage form (e.g., an on-vehicle instrument panel) of the display device, the second set of chromatic balance coordinates can be set at an arbitrary position if it is inside the triangle. In addition, the number of sets of second chromatic balance coordinates is not limited to one but may be set to be plural.

In the first exemplary embodiment, as an example of the second set of chromatic balance coordinates, the coordinates of point “b” in the chromaticity diagram is used. The second set of chromatic balance coordinates represents yellow or orange. The following Table 2 shows the first set of chromatic balance coordinates (point “a”) and the second set of chromatic balance coordinates (point “b”) by using coordinates in the chromaticity diagram and the luminance ratio of the first to third (RGB) pixel components.

TABLE 2

| | |
|---|---|
| Balance Coordinates | RGB Luminance Ratio |

| Sign | x | y | R | G | B |
|---|---|---|---|---|---|
| a | 0.33 | 0.33 | 0.2 | 0.53 | 0.27 |
| b | 0.43 | 0.38 | 0.32 | 0.54 | 0.14 |

As shown in Table 2, regarding the second set of chromatic balance coordinates of point “b”, the luminance ratio of the third (B) pixel component is smaller than the luminance ratios of the first (R) and second (G) pixel components. Accordingly, by continuously displaying the color represented by the second set of chromatic balance coordinates, a utilization factor of the third (B) pixel component is smaller than utilization factors of the first (R) and second (G) pixel components, so that the life of the third (B) pixel component can be extended than that of the third (B) pixel component in the first set of chromatic balance coordinates.

FIG. 2 shows an example of a relationship (long-term deterioration characteristic) between emission time and luminance of the first (R), second (G), and third (B) pixel components in the display device. In other words, FIG. 2 shows data obtained by continuously supplying a constant current and measuring luminances at predetermined time intervals concerning each of the first to third (RGB) pixel components. The first to third (RGB) pixel components are formed by, for example organic EL elements. As shown in FIG. 2, in the first embodiment, the second (G) pixel component has the longest life, the first (R) pixel component has the next longer life, and the third (B) pixel component has the shortest life.

Accordingly, in the display device, by continuously displaying the color represented by the second set of chromatic balance coordinates, the utilization factor of the third (B) pixel component is decreased, whereby the life of the third (B) pixel component can be extended. Conversely, the lives of the first (R) and second (G) pixel components are shortened. Therefore, in accordance with the display device according to the first embodiment, the first (R), second (G), and third (B) pixel components can have equal lives, thus enabling an extension in life of the display device.

In addition, although only the first (R) and second (G) pixel components can display various colors, a color reproduction range is narrow. By emitting light so that the luminance of the third (B) pixel component is less than that of the third (B) pixel component in the first set of chromatic balance coordinates of point “a”, the display device can suppress color shifting while maintaining the color reproduction range.

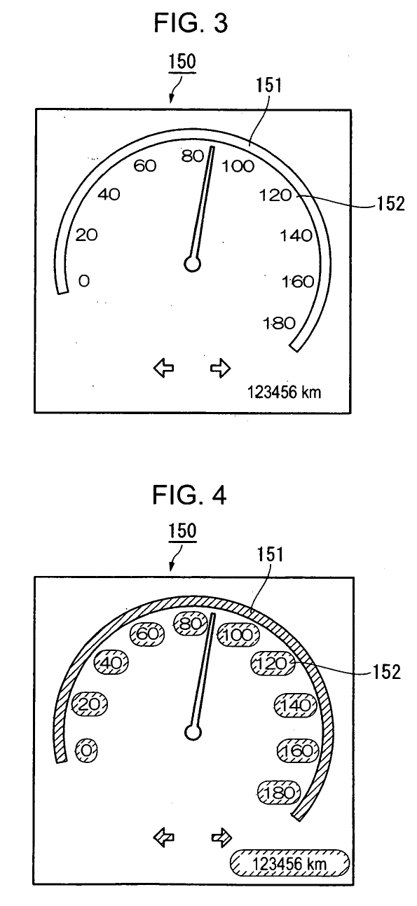

FIGS. 3 and 4 are schematic illustrations showing an example of (part of) an on-vehicle instrument panel 150 including the display device according to the first exemplary embodiment. The on-vehicle instrument panel 150 shown in FIGS. 3 and 4 is a display portion having an entire light-emitting surface that is self-emitting. Therefore, the entire surface becomes, for example, black in a power-off mode. The on-vehicle instrument panel 150 is used in a light-emitting state, even if it is placed, for example, in a bright place in daytime, or in a dark place such as nighttime or a tunnel. In FIGS. 3 and 4, the on-vehicle instrument panel 150 displays instruments, such as a speedometer outline 151 and numerals 152. The on-vehicle instrument panel 150 normally displays the instruments by using the second set of chromatic balance coordinates. FIG. 4 shows an example of a case in which color shifting occurs in the speedometer outline 151 and the numerals 152.

In addition, the on-vehicle instrument panel 150 can function also as a rear-view monitoring unit, and can display a vehicle state, such as malfunction, a natural image of a videophone, etc. Only when such high-quality image display is needed does the on-vehicle instrument panel 150 use the first set of chromatic balance coordinates.

In most of a vehicle-operating time, the on-vehicle instrument panel 150 uses the second set of chromatic balance coordinates for display. Accordingly, a display time with the first set of chromatic balance coordinates is smaller than that with the second set of chromatic balance coordinates. It is, for example, 5% or less. For the on-vehicle instrument panel 150, a luminance of 1/10 or less of that in daytime is sufficient in nighttime. If, for example, the luminance is 150 [cd/m²] in daytime and is 15 [cd/m²] in nighttime, the first set of chromatic balance coordinates is used for display in nighttime.

Accordingly, in the on-vehicle instrument panel 150, equalization of luminance decreasing factors of the first (R), second (G), and third (B) pixel components is achieved, thus well suppressing color shifting (discoloration) as shown in FIG. 4.

To switch between the first and second sets of chromatic balance coordinates, the luminance ratio of the first (R), second (G), and third (B) pixel components may be switched. In addition, to switch the luminance ratio, the following techniques are employed.

A first technique changes the ratio of values of currents supplied to organic EL elements forming the first (R), second (G), and third (B) pixel components. The smaller the values of the currents, the lower the luminances. However, the luminance decreasing factor decreases, so that the lives of the organic EL devices can be extended.

A second technique changes the emission time of each organic EL element forming each pixel. For example, by driving each pixel with rectangular waves having a frequency of 100 Hz or greater, and changing a duty ratio for each of the first to third pixel components, an apparent luminance ratio (ratio of average luminances per unit time) can be changed.

A third technique changes an emission area ratio of organic EL elements forming the first (R), second (G), and third (B) pixel components. For example, a plurality of pixels are used to form a display device, and each pixel includes at least four pixel components. In addition, by changing the emission area ratio of the first to third pixel components, a luminance ratio of the entire screen or predetermined region is changed.

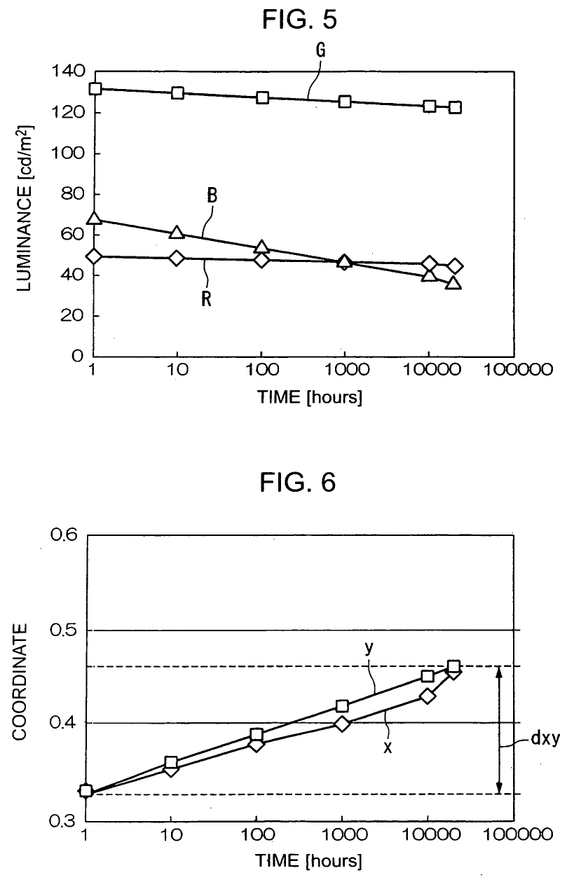

FIG. 5 is a graph showing a change in luminance of each pixel component when the display device according to the first exemplary embodiment continuously displays white in the first set of chromatic balance coordinates. As shown in FIG. 5, the luminance decreasing factor of the third (B) pixel component is larger than those of the first (R) and second (G) pixel components.

FIG. 6 is a graph showing, when a color is continuously displayed, a change in the display color. In other words, in FIG. 6, when the display device according to the first embodiment continuously displays white, a color change state of composite light of light components from the first to third pixel components is shown. As shown in FIG. 6, as the display time is longer, the composite light has a color represented by greater x-coordinate and y-coordinate in the chromaticity diagram, so that the composite light has a color (yellow) represented by coordinates (0.33, 0.33) at a great distance from the coordinates of white. For example, the color of the composite light after elapse of 20000 hours is a color represented by coordinates (0.46, 0.46), which are at a distance by d_{xy} (0.13, 0.13).

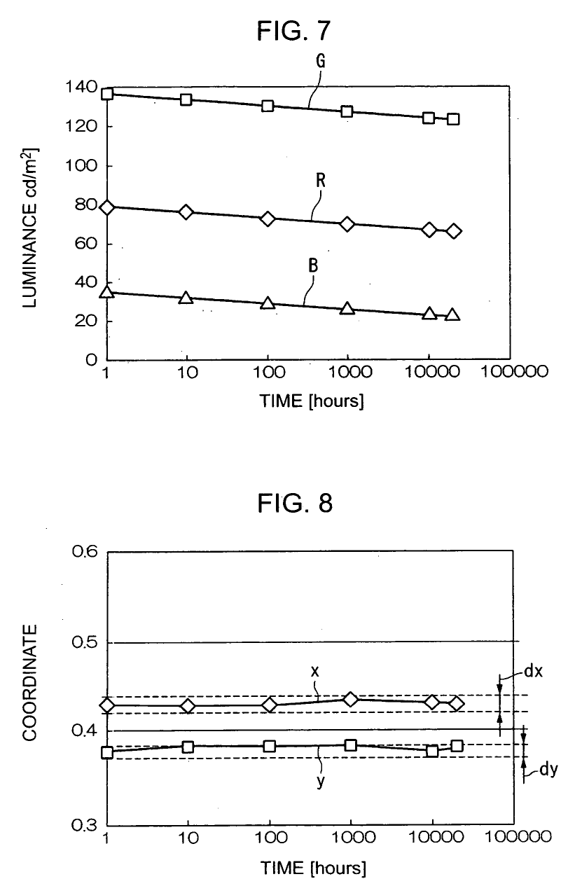

FIG. 7 is a graph showing, when the display device according to the first exemplary embodiment continuously displays a color in the second set of chromatic balance coordinates, a change in luminance of each pixel component. As shown in FIG. 7, the luminance decreasing factors o the first (R), second (G), and third (B) pixel components are approximately similar.

FIG. 8 is a graph showing, when the display device according to the first exemplary embodiment continuously displays the color in the state shown in FIG. 7, a change in color of the display color. In other words, in FIG. 8, when the display device according to the first embodiment continuously displays yellow color (or orange color) in the second set of chromatic balance coordinates, a color change state of the composite light of the light components from the first to third pixel components is shown. As shown in FIG. 8, even in the case of a long display time, the color of the composite light almost does not change both in x-coordinate and in y-coordinate. Specifically, a change in color of the composite light has extremely small values dₓ and d_{y} in the chromaticity diagram, which cannot be recognized by human eyes.

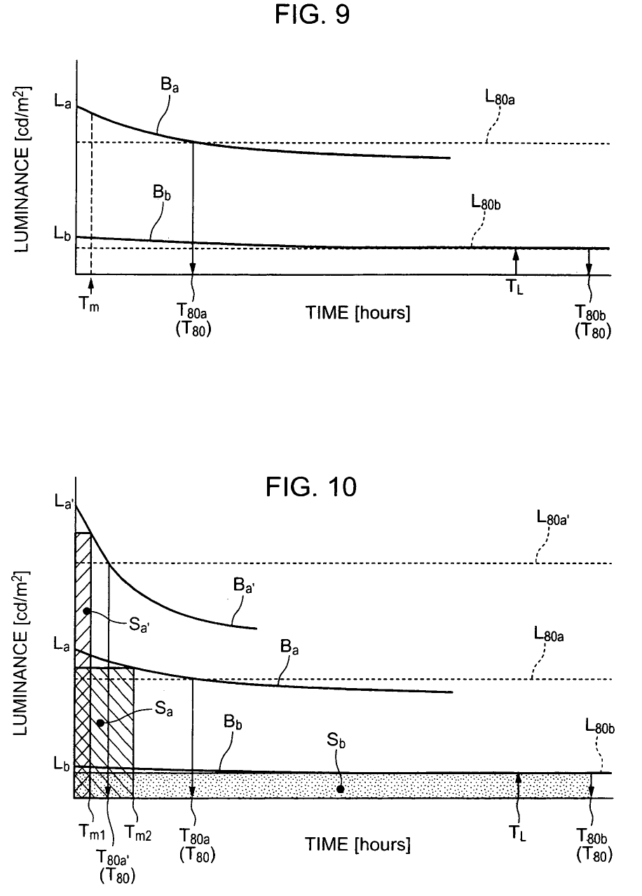

FIG. 9 is a graph showing relationships between (two) initial luminances and life (luminance threshold) of the third (B) pixel component in the display device according to the first embodiment. In FIG. 9, the horizontal axis indicates an emission time, and the vertical axis indicates luminance.

When a time in which the luminance of the third pixel component deteriorates by 20% is represented by T₈₀, and the necessary life of the display device according to the first embodiment is represented by T_{L}, in order for the display device to may normally operate having the life T_{L}, the following relationship is needed:
T₈₀>T_{L} (1)

In FIG. 9, the initial value of the luminance of the third (B) pixel component, when the display device according to the first embodiment displays white in the chromatic balance coordinates, is represented by Lₐ. A luminance change obtained when the third (B) pixel component continuously emits light at the initial luminance Lₐ is represented by Ba. The luminance L₈₀ₐ in FIG. 9 represents 80% of luminance Lₐ. In addition, time T₈₀ in which the luminance of curve Bₐ deteriorates by 20% is represented T₈₀ₐ. T₈₀ₐ and T_{L} has the following relationship:
T₈₀ₐ<T_{L} (2)

Therefore, if the display device according to the first embodiment continuously displays the color in the first set of chromatic balance coordinates, the display device becomes defective before the necessary life of the display device expires.

The initial value of the luminance of the third (B) pixel component in order to satisfy the relationship in expression (1) is L_{b} in FIG. 9. A luminance curve obtained when the third (B) pixel component continuously emits light at the initial luminance L_{b} is curve B_{b}. The luminance L_{80b} in FIG. 9 represents 80% of luminance L_{b}. In addition, time T₈₀ in which the luminance indicated by curve Bb deteriorates by 20% is represented by T_{80b}, and the following relationship holds:
T_{80b}>T_{L} (3)

A state in which the third (B) pixel component emits light at initial luminance L_{b} is called a driving state of the third (B) pixel component in the second set of chromatic balance coordinates in the first embodiment. As described above, the display device according to the first embodiment continuously displays color in the state of the second set of chromatic balance coordinates, whereby it can normally operate having desired life T_{L}.

In addition, within time Tₘ, which is shorter than time T₈₀ₐ, the display device according to the first embodiment may display an image having color using the first set of chromatic balance coordinates. In other words, within shorter time Tₘ, an image (natural image), such as scene or person input by a camera, may be displayed in colors using the first set of chromatic balance coordinates. For example, when the display device according to the first embodiment is applied to an on-vehicle instrument panel, an image behind the vehicle can be displayed in high-definition color for back monitoring at luminance Lₐ (in the first set of chromatic balance coordinates) within shorter time Tₘ, and representations of measuring instruments, such as a speedometer, can be displayed at luminance L_{b} (in the second set of chromatic balance coordinates) within longer time T_{80b}.

When the display device according to the first embodiment is applied to an on-vehicle instrument panel having a polarizer, luminance Lₐ is set to, for example, approximately 30 to 50 [cd/m²], and luminance L_{b} is set to, for example, approximately 3 to [cd/m²]. The life T_{L} required for the on-vehicle instrument panel is approximately 20000 hours.

FIG. 10 is a graph showing relationships between (three) initial luminances and life (luminance threshold) of the third (B) pixel component in the display device according to the first embodiment. FIG. 10 shows curve B_{a′} other than the curves Bₐ and B_{b} shown in FIG. 9. Curve B_{a′} indicates a luminance change when the third (B) pixel component continuously emits light at initial luminance L_{a′}. Initial luminance L_{a′} is approximately the double the initial luminance Lₐ.

Initial luminance L_{a′} is a high value and the luminance of the third (B) pixel component when the natural image is displayed with high definition in colors by using the first set of chromatic balance coordinates. Pixel component driving at initial luminance L_{a′} is used only in shorter time Tₘ₁ when the natural image is displayed by using the first set of chromatic balance coordinates. Furthermore, initial luminance L_{a′} is used when accurate recognition of information is needed, such as display of a monitored rear view, particularly in such a light place that, in daytime, the inside of the vehicle has sunlight.

Initial luminance Lₐ corresponds to the luminance Lₐ shown in FIG. 9, is an intermediate luminance, and the luminance of the third (B) pixel component when the first set of chromatic balance coordinates is used to display a natural image with high definition in colors. Pixel component driving at initial luminance Lₐ is used only in shorter time Tₘ₂ when the first set of chromatic balance coordinates is used to display the natural image. Since luminance Lₐ is lower than luminance L_{a′}, time Tₘ₂ is set to be longer than time Tₘ₁. In addition, initial luminance Lₐ is used when accurate recognition of information is needed, such as rear-view monitoring display, in a place that is not so bright.

Initial luminance L_{b} corresponds to the luminance L_{b} shown in FIG. 9, is a low luminance, and the luminance of the third (B) pixel component when the second set of chromatic balance coordinates is used to display a measured result from the measuring instrument. In addition, initial luminance L_{b} may be used when the second set of chromatic balance coordinates is used to display a natural image at a low luminance. This is because even a set low luminance is used to obtain a relatively good natural image since there is a dark place around the display device.

In the display device according to the first exemplary embodiment, the initial luminances (set luminance) and the sets of chromatic balance coordinates can be switched. For example, an emission-time limiting integration value that is the product of an initial luminance and a time for allowing emission is determined beforehand. In addition, the initial luminance and the chromatic balance coordinates are controlled to be switched so that the display device according to the first embodiment can emit light until desired life within the emission-time limiting integration value. In FIG. 10, the emission-time limiting integration value at initial luminance L_{a′} is region S_{a′}, the emission-time limiting integration value at initial luminance Lₐ is region Sₐ, and the emission-time limiting integration value at initial luminance L_{b} is region S_{b}.

As described above, in the display device according to the first embodiment, not only the luminance, but also the sets of chromatic balance coordinates can be switched. In other words, the display device according to the first embodiment can display a high-definition color image by using the first set of chromatic balance coordinates, and has a long life while enabling display of a color image by using the second set of chromatic balance coordinates. In other words, in the display device according to the first embodiment, when deterioration speeds of the first to third pixel components which emit primary-color light components differ, color shifting due to elapse of time can be avoided. When the display device according to the first embodiment is applied to an on-vehicle instrument panel, color changing can be easily performed without changing digital data defining a color image. This can extend the flexibility of the design of the on-vehicle instrument panel.

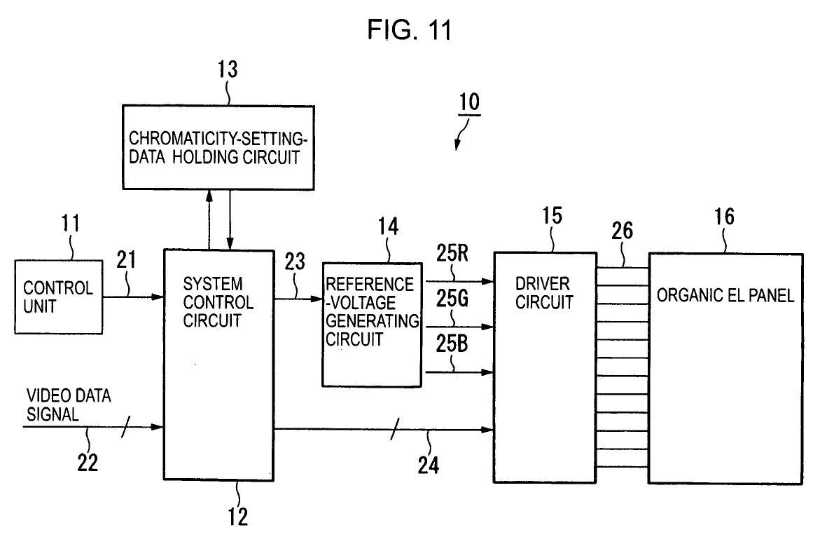

FIG. 11 is a block diagram showing an example of the specific configuration of a display device 10 according to the first exemplary embodiment. The display device 10 can include a control unit 11, a system control circuit 12, a chromaticity-setting-data holding circuit 13, a reference-voltage generating circuit 14, a driver circuit 15, and an organic EL panel 16.

The control unit 11 controls the overall operation of the entirety of the display device 10. The control unit 11 serves as a coordinate switching control unit according to an embodiment of the invention. As described with reference to FIGS. 9 and 10, the control unit 11 outputs a luminance-and-chromaticity-switching control signal 21 for switching a luminance and chromatic balance coordinates.

The system control circuit 12 receives the luminance-and-chromaticity-switching control signal 21, and generates and outputs a reference-voltage specifying value 23 based on the luminance-and-chromaticity-switching control signal 21. The reference-voltage specifying value 23 has specifying values (VLR, VLG, VLB) for each set of the first to third pixel components. For example, reference-voltage specifying value VLB for the third (B) pixel component may be three types of voltages set in proportional to the initial luminances L_{a′}, Lₐ, and L_{b} in FIG. 10. In addition, reference-voltage specifying value VLB may be set so as to correspond to the first and second sets of chromatic balance coordinates. The system control circuit 12 receives a video data signal 22 representing a color image, performs processing, such as amplification, on the video data signal 22, and outputs the processed signal.

The chromaticity-setting-data holding circuit 13 stores chromaticity-setting data that is used when the system control circuit 12 generates the reference-voltage specifying value 23. The chromaticity-setting data may be set beforehand by using, as parameters, luminance and chromatic balance coordinates included in the luminance-and-chromaticity-switching control signal 21. In addition, the chromaticity-setting data contains, for example, data which is set correspondingly to each pixel component of each pixel included in the organic EL panel 16. A value represented by chromaticity-setting data of a pixel component can be set to correspond to the luminance of the pixel component, that is, to a current supplied to the pixel component. Accordingly, by receiving chromaticity-setting data corresponding to the luminance-and-chromaticity-switching control signal 21 from the chromaticity-setting-data holding circuit 13, the system control circuit 12 can generate the reference-voltage specifying value 23.

The reference-voltage generating circuit 14 can receive the reference-voltage specifying value 23, performs conversion, and outputs obtained reference voltages 25R, 25G, and 25B which respectively correspond to the first to third pixel components of each pixel of the organic EL panel 16. The reference voltages 25R, 25G, and 25B are digital data items.

The driver circuit 15 receives the video data signal 24 and the reference voltages 25R, 25G, and 25B, and outputs, correspondingly to these inputs, selective driving signals 26 that selectively drive the pixel components in the organic EL panel 16. The organic EL panel 16 is driven by the selective driving signals 26 to display a color image.

In the display device 10 according to the first exemplary embodiment, based on the luminance-and-chromaticity-switching control signal 21 output from the control unit 11, not only the luminance but also the first and second sets of chromatic balance coordinates can be switched. Thus, when the deterioration speeds of the first to third pixel components differ, the color (display color) can be changed without changing the chromaticity-setting data, and, in addition, pixel component lives can be extended by avoiding color shifting due to elapse of time.

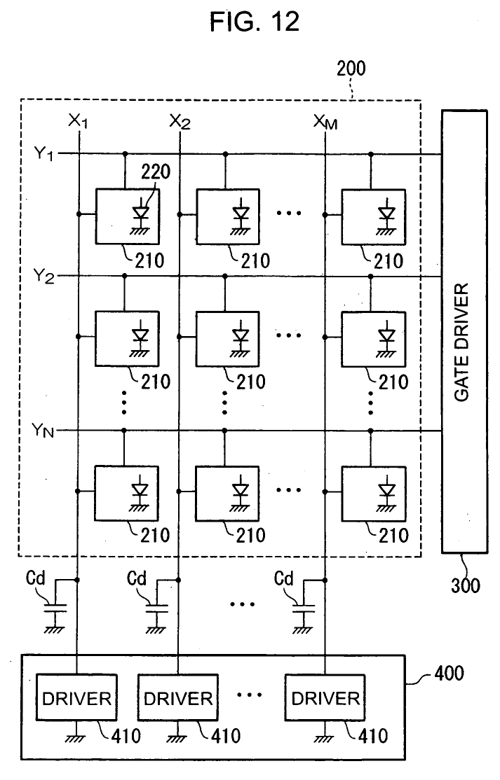

FIG. 12 is an exemplary circuit diagram showing specific examples of the driver circuit 15 and organic EL panel 16 in the display device 10 shown in FIG. 11. The display matrix 200 shown in FIG. 12 corresponds to the organic EL panel 16 shown in FIG. 11. The gate driver 300 and data-line driver 400 shown in FIG. 12 correspond to the driver circuit 15 shown in FIG. 11.

The display matrix 200 can include a plurality of pixel component circuits 210 arranged in matrix form, each circuit 210 including an organic EL element 220 (first, second, or third pixel component). The matrix of the pixel component circuits 210 connects to a plurality of data lines Xₘ (m=1 to M) extending in the column direction of the matrix, and to a plurality of gate lines Yₙ (n=1 to N) extending in the row direction of the matrix. The data lines Xₘ are also called the “source lines” Xₘ, and the gate lines Yₙ are also called the “scanning lines” Yₙ. In addition, in the first exemplary embodiment, the pixel component circuits 210 are also called the “unit circuits” or “pixel components” 210. As transistors in the pixel component circuits 210, thin film transistors (TFTs) are normally used.

The gate driver 300 selectively drives one of the gate lines Yₙ to select the pixel component circuits for one row. The data-line driver 400 includes a plurality of single-line drivers 410 for driving the data lines Xₘ. The single-line drivers 410 supply data signals to the pixel component circuits 210 through the data lines Xₘ. The internal state of each pixel component circuit 210 is set in response to each date signal. In accordance with the set internal state, the value of a current flowing in each organic EL element 220 is controlled, and, as a result, the gray scale (luminance) of the organic EL element 220 is controlled.

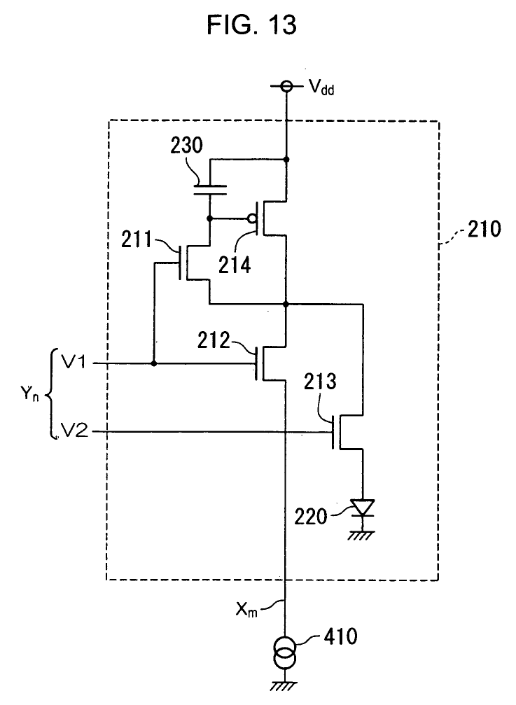

FIG. 13 is a circuit diagram showing the internal configuration of the pixel component circuit 210. The pixel component circuit 210 is disposed at the intersection of the m-th date line and the n-th gate line. The gate line can include two sub-gate lines V1 and V2.

The pixel component circuit 210 is a current program circuit that adjusts the gray scale (luminance) of the organic EL element 220 in accordance with the value of the current flowing in the date line. Specifically, the pixel component circuit 210 includes, in addition to the organic EL element 220, four transistors 211 to 214 and a holding capacitor 230 (also called a holding capacitor or storage capacitor 230). The holding capacitor 230 holds electric charge in accordance with the data signal supplied from the m-th data line, and is used to adjust the gray scale of emission of the organic EL element 220 based on the charge held. In other words, the holding capacitor 230 corresponds to a voltage holding unit for holding a voltage in accordance with the current flowing in the m-th data line. The first to third transistors 211 to 213 are n-channel FETs, and the fourth transistor 214 is a p-channel FET. The organic EL element 220 is here indicated by the symbol of a diode since it is a current-injection (current-driven) light-emitting element similar to a photodiode.

The source of the first transistor 211 is connected to the drains of the second transistor 212, the third transistor 213, and the fourth transistor 214. The drain of the first transistor 211 is connected to the gate of the fourth transistor 214. The holding capacitor 230 is connected between the source and gate of the fourth transistor 214, and the source of the fourth transistor 214 is also connected to have power-supply potential V_{dd}.

The source of the second transistor 212 is connected to the single-line driver 410 by the data line Xₘ. The organic EL element 220 is connected between the source of the third transistor 213 and the ground potential.

The gates of the first and second transistors 211 and 212 are connected in common to the first sub-gate line V1. The gate of the third transistor 213 is connected to the second sub-gate line V2.

The first and second transistors 211 and 212 are switching transistors for use in storing electric charge in the holding capacitor 230. The third transistor 213 is a switching transistor that is maintained to be in an on-state during an emission period of the organic EL element 220.

In addition, the fourth transistor 214 is a driving transistor for controlling the value of the current flowing in the organic EL element 220. The current value of the fourth transistor 214 is controlled by the quantity of electric charge (quantity of stored charge) held in the holding capacitor 230.

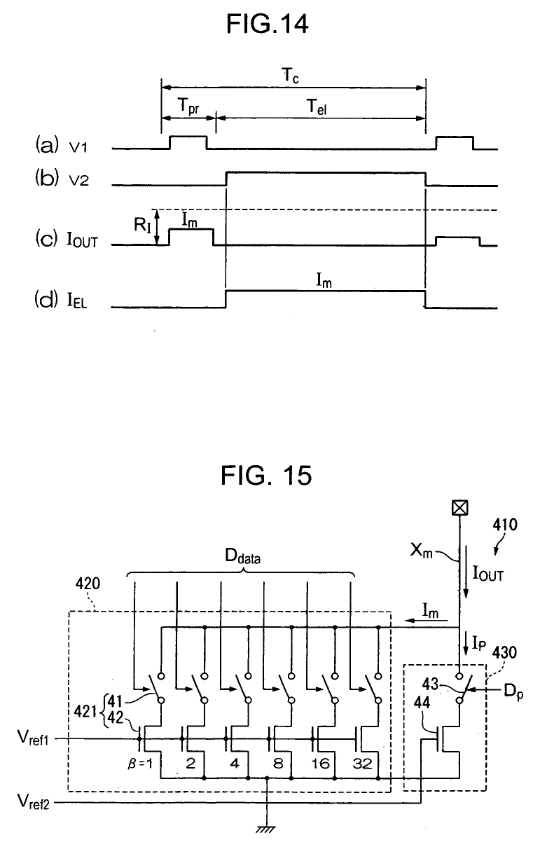

FIG. 14 is a timing chart showing the normal operation of the pixel component circuit 210. In FIG. 14, part (a) shows the voltage (hereinafter referred to also as the first gate signal V1) of the first sub-gate line V1, part (b) shows the voltage (hereinafter referred to also as the second gate signal V2) of the second sub-gate line V2, part (c) shows the current Iₒᵤₜ (also referred to as data signal Iₒᵤₜ) of data line Xₘ, and part (d) shows the value I_{EL} of the current following in the organic EL element 220.

Driving period T_{c} is divided into programming period Tₚᵣ and emission period Tₑₗ. Here, the driving period T_{c} can mean a period in which the gray scale of emission of all the organic EL elements 220 in the display matrix 200 is updated each time, and is identical to a so-called frame period. Updating of the gray scale is performed for each set of the pixel component circuits 210 for one row. During driving period T_{c}, gray scales of emission by the organic EL elements 220 for N rows are sequentially updated. For example, when gray scales of emission by all the organic EL elements 220 are updated, driving period T_{c} is approximately 33 milliseconds.

Programming period Tₚᵣ is a period in which the gray scale of emission by the organic EL element 220 is set in the pixel component circuit 210. In the first embodiment, setting of the gray scale in the pixel component circuit 210 is called programming. For example, when driving period T_{c} is approximately 33 milliseconds, and the total number N of gate lines Yₙ is 480, programming period Tₚᵣ is approximately 69 microseconds (=33 milliseconds/480) or less.

In programming period Tₚᵣ, at first, by setting the second gate signal V2 to a low (L) level, the third transistor 213 is maintained to be in an off-state (closed state). Next, by setting the first gate signal V1 to a high (H) level while supplying data lines Xₘ with current value Iₘ in accordance with the gray scale of emission, the first and second transistors 211 and 212 are set to an on-state (open state). At this time, the single-line drivers 410 for data lines Xₘ function as constant current generators for supplying constant current value Iₘ in accordance with the gray scale of emission. As shown in part (c) of FIG. 14, current value Iₘ is set to a value in accordance with the gray scale of emission by the organic EL elements 220 in predetermined current range R_{I}.

The holding capacitor 230 enters a state that holds electric charge corresponding to current value Iₘ flowing in the fourth transistor 214 (driving transistor). As a result, the voltage stored in the holding capacitor 230 is applied between the source and gate of the fourth transistor 214. In this specification, the current value Iₘ of the data signal for use in programming is called the programming current value Iₘ.

When the programming finishes, the gate driver 300 sets the first gate signal V1 to the L level and sets the first and second transistors 211 and 212 to the off-state. In addition, the data-line driver 400 stops data signal Iₒᵤₜ.

In emission period Tₑₗ, while maintaining the first and second transistors 211 and 212 to be in the off-state by maintaining the first gate signal V1 to the L level, the second gate signal V2 is set to the H level to set the third transistor 213 to the on-state. The holding capacitor 230 stores a voltage corresponding to programming current value Iₘ beforehand. Thus, a current that is approximately equal to programming current value Iₘ flows in the fourth transistor 214. Accordingly, a current that is approximately equal to programming current value Iₘ flows also in the organic EL element 220, and the organic EL element 220 emits light at a gray scale corresponding to the flowing current value Iₘ. The pixel component circuit 210, which is of a type in which, as described above, the voltage (i.e., electric charge) of the holding capacitor 230 is written based on current value Iₘ, is called the current program circuit.

FIG. 15 is a circuit diagram showing the internal configuration of the single-line driver 410. The single-line driver 410 includes a data signal generating circuit 420 (also referred to as a control current generator or current generating circuit 420) and an additional current circuit 430 (also referred to as an additional current generator).

The data signal generating circuit 420 and the additional current circuit 430 are connected in parallel to each other between data line Xₘ and the ground potential.

In the data signal generating circuit 420, N (N represents an integer not less than 2) series-connection portions 421 are connected in parallel to one another, each including a switching transistor 41 and a driving transistor 42 which are connected in series. In the example shown in FIG. 15, N is six. Accordingly, reference voltage V_{ref1} is applied in common to the gates of six driving transistors 42. In addition, the ratio of gain coefficients β of the six driving transistors 42 is set to 1:2:4:8:16:32. As is well-known, gain coefficient β is defined by β=(μC₀W/L), where μ represents a carrier mobility, C₀ represents a gate capacitance, W represents a channel width, and L represents a channel length. The six driving transistors 42 function as a constant current generator. Since the current-driven capability of a transistor is in proportion to gain coefficient β, the ratio of capabilities of the six driving transistors 42 is 1:2:4:8:16:32.

Switching on and off of the six switching transistors 41 is controlled by six-bit data-line driving signal D_{data} (also referred to as an input signal) included in the video data signal 22 supplied from the system control circuit 12. The least significant bit of data-line driving signal D_{data} is supplied to one series-connection portion 421 having the least gain coefficient β (i.e., a relative value of β being 1), and the most significant bit of data-line driving signal D_{data} is supplied to one series-connection portion 421 having the largest gain coefficient β (i.e., a relative value of β being 32). As a result, the data signal generating circuit 420 functions as a current generator for generating current value Iₘ in proportion to the value of data-line driving signal D_{data}. The value of data-line driving signal D_{data} is set to a value representing the gray scale of emission of the organic EL element 220. Therefore, the data signal generating circuit 420 outputs a data signal having current value Iₘ in accordance with the gray scale (luminance) of emission of the organic EL element 220.

The additional current circuit 430 includes a switching transistor 43 and a driving transistor 44 which are connected in series. Reference voltage V_{ref2} is applied to the gate of the driving transistor 44. Switching on and off of the switching transistor 43 is controlled by additional-current-control signal Dₚ included in the video data signal 22 supplied from the system control circuit 12. When the switching transistor 43 is in the on-state, predetermined additional current Iₚ in accordance with reference voltage V_{ref2} is output from the additional current circuit 430 to data line Xₘ.

Next, an electronic apparatus that includes, as a component, the display device 10 (as an electro-optic device) according to the first embodiment is described below.

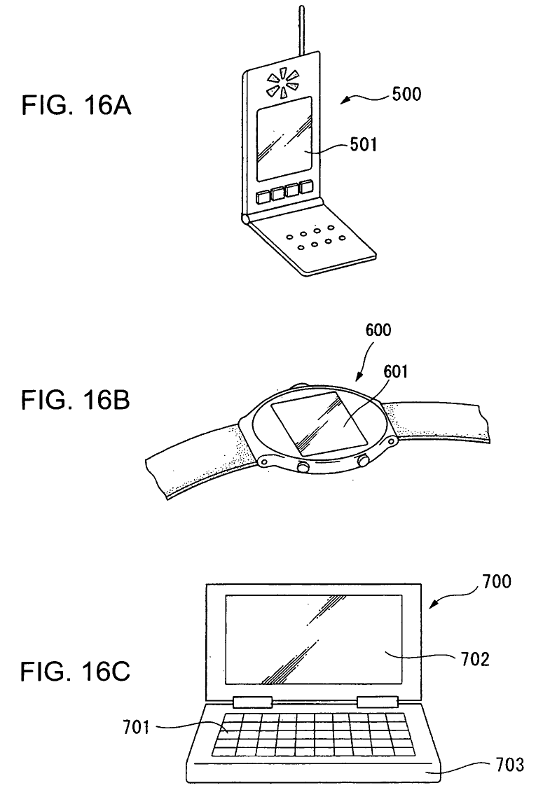

FIG. 16A is a perspective view of an example of a cellular phone. FIG. 16A shows a cellular phone 500 and a display portion 501 including the display device 10 according to the first exemplary embodiment. FIG. 16B is a perspective view of an example wristwatch electronic apparatus. FIG. 16B shows a wristwatch 600 and a display portion 601 including the display device 10 as the display device according to the first exemplary embodiment. FIG. 16C is a perspective view of an example portable information processing apparatus such as a word processor or a personal computer. FIG. 16C shows an information processing apparatus 700, an input unit 701 such as a keyboard, a display portion 702 including the display device 10 according to the first embodiment, and an information-processing-apparatus system unit 703.

Each of the electronic apparatuses shown in FIGS. 16A to 16C includes the display device 10 according to the first embodiment. Thus, even if long-term deterioration characteristics of pixel components for displaying fundamental (primary) colors, such as red, green, and blue, differ depending on the colors, the electronic apparatus can display desired colors over a long period. In other words, according to this embodiment, an electronic apparatus including a display device which can display a color image, which can prevent color shifting from occurring over a long period, and which has a long life can be provided. The display device 10 according to the first exemplary embodiment of the invention is particularly suitable for electronic apparatuses in each of which a natural image and a non-natural image, such as a computer graphics image or character information, are selectively switched for display.

A display device according to a second exemplary embodiment of the invention is described below with reference to the accompanying drawings.

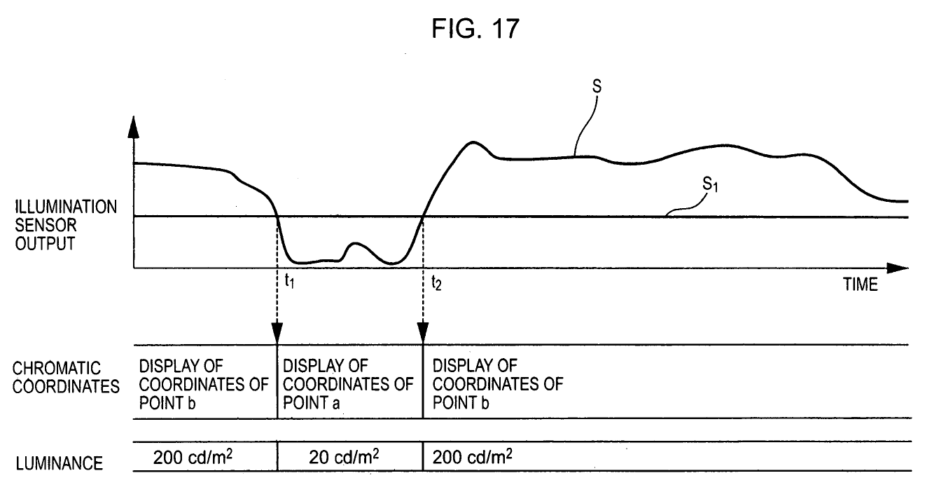

Examples of the basic configuration and operation of the display device according to the second embodiment are described by using FIGS. 1 to 17. Here, a description of FIG. 1 is omitted since it is identical to that in the first exemplary embodiment. FIG. 17 is a graph in which its horizontal axis indicates a time and its vertical axis indicates an illumination sensor output. Also, in FIG. 17, along the time-indicating horizontal axis, chromatic balance coordinates (chromatic coordinates) and luminances used in the display device according to the second embodiment are shown. In FIG. 17, the chromatic balance coordinates mean the coordinates in the chromaticity diagram of white, which serves as a reference color for use in adjusting, for example, white balance, and define a reference color for a color displayed on a display portion of the display device according to the second exemplary embodiment.

The display device according to the second embodiment includes a color control unit, a luminance control unit, and an illumination sensor (illumination detecting unit).

The color control unit has two sets of chromatic balance coordinates, and uses one of the two sets to control a display color on the display portion. Of the two set of chromatic balance coordinates, one is a first set of chromatic balance coordinates (coordinates a), and the other is a second chromatic balance coordinates (coordinates b). The luminance control unit controls the luminance of the display portion.

Also in the second exemplary embodiment, by way of example, coordinates (0.43, 0.38) represented by point “b” in the chromaticity diagram are used as the second set of chromatic balance coordinates.

In addition, also in the display device according to the second embodiment, when emitting light, by setting the luminance of the third (B) pixel component to be lower than those of the first (R) and second (G) pixel components, color shifting can be suppressed while ensuring a color reproduction range.

Furthermore, as shown in FIG. 17, in the display device according to the second exemplary embodiment, the color control unit can switch the sets of chromatic balance coordinates. Specifically, the color control unit uses the second set of chromatic balance coordinates (coordinates b) when illumination sensor output S is greater than predetermined threshold value S₁, and uses the first set of chromatic balance coordinates (coordinates a) when illumination sensor output S is less than predetermined threshold value S₁. Therefore, in the second embodiment, in the period of time t₁ to time t₂, a high-definition color image (such as a natural image) having a broad color reproduction range using the first set of chromatic balance coordinates is displayed. In addition, in periods other than the period between time t₁ and time t₂, the second set of chromatic balance coordinates is used for display, thus achieving an extended life.

Furthermore, as shown in FIG. 17, in the display device according to the second embodiment, the luminance of the display portion can be controlled by the luminance control unit. Specifically, when illumination sensor output S is greater than predetermined threshold value S₁ (in the periods other than the period between time t₁ and time t₂), the luminance control unit controls the luminance to a high value of 200 [cd/m²]. When illumination sensor output S is less than predetermined threshold value S₁ (in the period between time t₁ and time t₂), the luminance control unit controls the luminance to a low value of 20 [cd/m²].

When illumination sensor output S is less, that is, when it is dark around the display portion, even if the display portion has a low luminance, a clear image can be displayed. Conversely, if the luminance is too high, an unclear image is displayed. Accordingly, according to the display device according to the second embodiment, when it is dark around the display portion, while displaying a clear image at a low luminance, a high-definition natural image can be displayed by using the first set of chromatic balance coordinates. The use of the low luminance in this case can extend the life of the display device according to the second embodiment.

As described above, according to the display device according to the second embodiment, switching of the sets of chromatic balance coordinates and switching of the luminances are associated with each other. Therefore, the display device according to the second embodiment can display a color image having a broad color reproduction range while equalizing the long-term deteriorations of pixel components. In addition, when displaying a color corresponding to a pixel component having a long life, the display device according to the second embodiment can also display a clear image at a high luminance.

When illumination sensor output S is greater, that is, when it is bright around the display portion, a clear image cannot be displayed unless the display portion has a high luminance. Accordingly, according to the display device according to the second embodiment, when it is bright around the display portion, while displaying a clear image at a high luminance, an extended life of the display device is achieved by using the second set of chromatic balance coordinates.

The display device according to the second embodiment is applicable to on-vehicle instrument panels, and may be designed to display not only representations of measuring instruments such as a speedometer and a tachometer, but also an image behind a vehicle. In this case, the illumination sensor is installed in the vicinity of the instrument panel. Accordingly, for the representations of the speedometer, etc., the second set of chromatic balance coordinates and high luminance display are automatically selected in a daytime running mode, and the first set of chromatic balance coordinates and low luminance display are selected in a nighttime running mode.

The switching of the sets of chromatic balance coordinates and the switching of the luminances may be performed when turning on and off headlights or small lamps for nighttime running. For example, when turning on the headlights, the first set of chromatic balance coordinates and the low luminance display may automatically be selected, and, when turning off the headlights, the second set of chromatic balance coordinates and the low luminance display may automatically be selected.

In addition, when the display device according to the second embodiment is applied to an instrument panel of a vehicle, it may be designed to display a (natural) image behind the vehicle, for example, when the vehicle is driven backward. Specifically, when the reverse gear of the vehicle is selected, the first set of chromatic balance coordinates and a desired luminance are automatically selected, whereby a clear image behind the vehicle can be displayed.

The display device according to the second embodiment may switch the chromatic balance coordinates and the luminance in response to a control signal from a communication line such as video telephone. For example, when a normal mode signal is received through the video telephone, the second set of chromatic balance coordinates and a second desired luminance are used to perform normal image display, thus achieving an extended life of the display device according to the second embodiment. When a high-definition-mode signal is received through the video telephone, the first set of chromatic balance coordinates and a first desired luminance are used to perform high-definition color-image display.

FIGS. 4 and 5 also show an example of (part of) an on-vehicle instrument panel including the display device according to the second exemplary embodiment. A description of FIGS. 4 and 5 is omitted since it is identical to that in the first embodiment.

Switching of the first and second sets of chromatic balance coordinates can be also performed based on illumination sensor output S, as described above.

Techniques for switching of the luminance ratio of the first (R), second (G), and third (B) pixel components include the techniques described in the first embodiment.

FIG. 5 also shows a change in luminance of each pixel component when the display device according to the second embodiment continuously displays white in the first set of chromatic balance coordinates. A description of FIG. 5 is omitted since it is identical to that in the first exemplary embodiment.

FIG. 6 also shows, when the color display is continuously performed in the state shown in FIG. 5, a change in the display color. A description of FIG. 6 is omitted since it is identical to that in the first exemplary embodiment.

FIG. 7 shows, when the display device according to the second exemplary embodiment continuously displays a color in the second set of chromatic balance coordinates, a change in luminance of each pixel component. A description of FIG. 7 is omitted since it is identical to that in the first exemplary embodiment.

FIG. 8 also shows, when the display device according to the second embodiment continuously displays the color in the state shown in FIG. 7, a change in color of the display color. A description of FIG. 8 is omitted since it is identical to that in the first embodiment.

FIG. 9 also shows relationships between (two) initial luminances and life (luminance threshold) of the third (B) pixel component in the display device according to the second embodiment. A description of the initial luminances and life of the display device according to the second embodiment is omitted since, as shown in FIG. 9, it is similar to that in the first exemplary embodiment. Also in the second exemplary embodiment, by continuously performing display in the second set of chromatic balance coordinates, the display device can normally operate having desired life T_{L}.

Similarly to the first exemplary embodiment, in the second embodiment, the display device may display an image in color using the first set of chromatic balance coordinates within time Tₘ shorter than time T₈₀ₐ.

FIG. 10 also shows relationships between (three) initial luminances and life (luminance threshold) of the third (B) pixel component in the display device according to the second embodiment. A description of the initial luminances and life of the third (B) pixel component is omitted since, as shown in FIG. 10, it is similar to that in the first embodiment.

Also in the display device according to the second embodiment, similarly to the first embodiment, in accordance with various circumstances such as daytime, nighttime, and a display item, the initial luminances and sets of chromatic balance coordinates can be switched. This point has been described in the first embodiment. Accordingly, it is not described here.

As described above, in the display device according to the second embodiment, the luminances and the sets of chromatic balance coordinates can be switched. In other words, this display device can display a high-definition color image by using the first set of chromatic balance coordinates, and can have an extended life although it can display a color image by using the second set of chromatic balance coordinates. Specifically, in the display device according to the second embodiment, when the deterioration speeds of the first to third pixel components for emitting primary color light components differ, color shifting due to elapse of time can be avoided. In addition, in the display device according to the second embodiment, by performing luminance switching in response to switching of chromatic balance coordinates, an extended display-device life can be achieved while improving display quality. Furthermore, when the display device according to the second embodiment is applied to an on-vehicle instrument panel, color change can be easily performed without changing digital data defining a color image, and the flexibility of the design of the on-vehicle instrument panel can also be expanded.

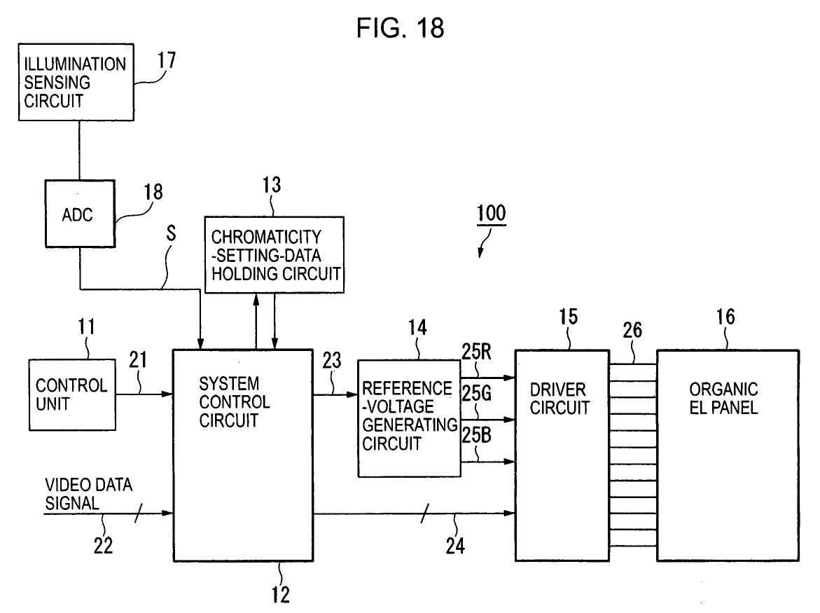

FIG. 18 is a block diagram showing a specific example of the configuration of a display device 100 as the display device according to the second exemplary embodiment. Regarding FIG. 18, by using identical reference numerals to denote components identical to those in the first exemplary embodiment shown in FIG. 11, their description is omitted. Similarly to the first embodiment, the display device 100 includes the control unit 11, the system control circuit 12, the chromaticity-setting-data holding circuit 13, the reference-voltage generating circuit 14, the driver circuit 15, and the organic EL panel 16, and further includes an illumination sensing circuit 17 and an analog-to-digital (A/D) converter (indicated by “ADC”) 18.

The control unit 11 corresponds to both a color control unit and luminance control unit according to an exemplary embodiment of the invention. As described above with reference to FIGS. 1 to 10, and FIG. 17, the control unit 11 outputs the luminance-and-chromaticity-switching control signal 21 that switches the luminance and the chromatic balance coordinates. The illumination sensing circuit 17 corresponds to the above illumination sensor (illumination detecting unit) and is installed in, for example, the vicinity of the organic EL panel 16. The illumination sensing circuit 17 can include, for example, a photodiode and an amplifying circuit. The A/D converter 18 outputs, to the system control circuit 12, a digital signal obtained by converting an analog signal that is illumination sensor output S from the illumination sensing circuit 17.

The system control circuit 12 receives the luminance-and-chromaticity-switching control signal 21 and the illumination sensor output S from the illumination sensing circuit 17, and generates and outputs a reference-voltage specifying value 23 based on these signals. The reference-voltage specifying value 23 has specifying values (VLR, VLG, and VLB) for each set of the first to third pixel components. For example, as reference-voltage specifying value VLB for the third (B) pixel component, three types of voltages set in proportion to the initial luminances L_{a′}, Lₐ, and L_{b} shown in FIG. 10 may be used. Reference-voltage specifying value VLB may be set correspondingly to the first and second sets of chromatic balance coordinates. In addition, the system control circuit 12 receives a video data signal 22 representing a color image, performs processing, such as amplification, on the signal, and outputs the processed signal.

The chromaticity-setting-data holding circuit 13 stores chromaticity-setting data that is used when the system control circuit 12 to generate the reference-voltage specifying value 23. The chromaticity-setting data may be set beforehand by using, as parameters, values which are included in the luminance-and-chromaticity-switching control signal 21 and which specify a luminance and chromatic balance coordinates, and the value of illumination sensor output S from the illumination sensing circuit 17. In addition, the chromaticity-setting data consists of plural data items that are set correspondingly to the pixel components of pixels forming the organic EL panel 16. Therefore, the value of the chromaticity-setting data of a pixel component can be set to a value corresponding to the luminance of the pixel component, that is, to a value corresponding to a current that flows in the pixel component. Accordingly, the system control circuit 12 can generate the reference-voltage specifying value 23 by receiving, from the chromaticity-setting-data holding circuit 13, the chromaticity-setting data corresponding to the luminance-and-chromaticity-switching control signal 21.

Based on the luminance-and-chromaticity-switching control signal 21 output from the control unit 11 and the illumination sensor output S from the illumination sensing circuit 17, the display device 100 according to the second embodiment switches the luminance and the chromatic balance coordinates. Thus, the deterioration speeds of the first to third pixel components differ, the color (display color) can be changed without changing the chromaticity-setting data, etc., thus avoiding color shifting due to elapse of time to enable an extended life. In addition, in the display device 100 according to the second embodiment, an extended life is achieved, with display quality improved, since the luminance and the chromatic balance coordinates can be set to be optimal.

FIG. 13 also shows the internal configuration of the pixel component circuit 210 in the second exemplary embodiment. A description of the internal configuration of the pixel component circuit 210 is omitted since it is identical to that in the first exemplary embodiment.

FIG. 14 also shows the normal operation of the pixel component circuit 210 in the second exemplary embodiment. A description of the normal operation of the pixel component circuit 210 is omitted since it is identical to that in the first exemplary embodiment.

FIG. 15 also shows the internal configuration of the single-line driver 410 in the second exemplary embodiment. A description of the internal configuration of the single-line driver 410 is omitted since it is identical to that in the first exemplary embodiment.

An electronic apparatus including, as a component, the display device 100 (as an electro-optical device) according to the second embodiment. The electronic apparatus is similar to that in the first embodiment, as shown in FIGS. 16A to 16C. Accordingly, this electronic apparatus is not described.

Each of the electronic apparatuses shown in FIGS. 16A to 16C includes the display device 100 according to the second embodiment. Thus, even if long-term deterioration characteristics of pixel components for displaying fundamental (primary) colors, such as red, green, and blue, differ depending on colors, the electronic apparatus can display desired colors over a long period. In other words, according to the second embodiment, an electronic apparatus including a display device which can display a high-definition color image, which can prevent color shifting from occurring over a long period, and which has a long life can be provided.

The display device 100 according to the second embodiment of the invention is particularly suitable for an electronic apparatus in which a natural image and a non-natural image, such as a computer graphics image or character information, are selectively switched for display. In addition, the display device 100 according to the second embodiment of the invention is particularly suitable for an electronic apparatus that is used not only in a light place but also in a dark place.

It should be understood that the technical scope of the invention is not limited to the foregoing exemplary embodiments, but may be variously modified without departing from the spirit and scope of the invention. Specific components, etc., described in the foregoing embodiments are only examples, and may be altered, if necessary.

For example, in the foregoing exemplary embodiments, each pixel is formed by pixel components corresponding to three primary colors (RGB). However, the invention is not limited to this formation, but the pixel component may be formed by pixel components corresponding to four, five, or more primary colors. In addition, two pixel components having different emission colors may form each pixel component. For example, when the pixel component is formed by four primary colors, a pixel component that emits one of cyan, magenta, and yellow light components is added to the RGB pixel components.

Although each of the foregoing exemplary embodiments describes an example of a display device in which organic EL elements are used as pixel components, the invention is not limited to this example. The display device according to each embodiment of the invention may be formed by using various types of electro-optical elements, etc., other than organic EL elements. In addition, the display device according to each embodiment of the invention is applicable to illumination devices other than display devices such as electro-optical devices. The illumination device is not a display device that displays, images, information, or the like, but is a device that emits a predetermined ray of light to a targeted object.

In addition, the display device according to each exemplary embodiment of the invention is applicable to operation panels for various type of household appliances, various types of measuring instruments, monitors including operation units, etc.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

What is claimed is:

1. A display device, comprising:
at least two sets of chromatic balance coordinates that define reference colors for a display color.

2. The display device according to claim 1,
one of the at least two sets of chromatic balance coordinates defining white.

3. The display device according to claim 1,
one of the at least two sets of chromatic balance coordinates representing a first set of coordinates in a chromaticity diagram having (x, y) space; and
a different set of chromatic balance coordinates representing a set of coordinates other than the first set of coordinates in the chromaticity diagram.

4. The display device according to claim 1, further comprising:
a coordinate-switching control unit that sets a utilization factor of chromatic balance coordinates defining white to be less than a utilization factor of chromatic balance coordinates defining another color.

5. The display device according to claim 1,
the display device having pixels, each pixel including at least two pixel components having different optical spectrum characteristics; and
the at least two sets of chromatic balance coordinates defining reference colors for a display color on the pixel.

6. The display device according to claim 5,
the pixel including a first pixel component that emits a light component having a first peak wavelength, a second pixel component that emits a light component having a second peak wavelength, and a third pixel component that emits a light component having a third peak wavelength;
the at least two sets of chromatic balance coordinates having a first set of chromatic balance coordinates and a second set of chromatic balance coordinates;
the first set of chromatic balance coordinates representing white; and
the second set of chromatic balance coordinates representing a color other than white.

7. The display device according to claim 6,
the second set of chromatic balance coordinates representing a color obtained by mixing, at a predetermined ratio, the light components emitted by the first, second, and third pixel components; and
representing a color obtained by mixing the light components which are emitted by the first, second, and third pixel components with the ratio of the light component of one pixel component set to be greater than the light components of the other pixel components, the one pixel component having the least long-term emission-luminance deterioration among the first, second, and third pixel components.

8. The display device according to claim 6, further comprising:
a display color control unit which controls the display color by using the first set of chromatic balance coordinates when a natural image is displayed, and which controls the display color by using the second set of chromatic balance coordinates when a measuring instrument image indicating a result of measurement by a measuring instrument is displayed.

9. An on-vehicle display device, having the configuration of the display device as set forth in claim 1 in a form installable in a vehicle.

10. The on-vehicle display device according to claim 9, the on-vehicle display device being provided on an instrument panel in the vicinity of a driver's seat in the vehicle.

11. An electronic apparatus, including the display device as set forth in claim 1.

12. A display method, comprising:
setting at least two sets of chromatic balance coordinates which define reference colors for a display color.

13. The display method according to claim 12,
one of the at least two sets of chromatic balance coordinates defining white; and
a utilization factor of the set of chromatic balance coordinates which defines white being less than a utilization factor of a different set of chromatic balance coordinates.

14. The display method according to claim 13,
an image being displayed by using pixels, each pixel including at least two pixel components having different optical spectrum characteristics; and
the different set of chromatic balance coordinates representing a color obtained by mixing, at a predetermined ratio, light components emitted by the pixel components of the pixel, and representing a color obtained by mixing the light components emitted by the pixel components, with the ratio of the light component of one pixel component set to be greater than the light components of the other pixel components, the one pixel component having the least the long-term emission-luminance deterioration among the pixel components.

15. The display method according to claim 13,
when the result of measurement by a measuring instrument is displayed, the different set of chromatic balance coordinates being used for display; and
when information other than the result of the measurement is displayed, the set of chromatic balance coordinates defining white being used for display.

16. A display device, comprising:
a color control unit which has at least two sets of chromatic balance coordinates defining reference colors for a display color on a display portion, and which controls the display color on the display portion by using one of the at least two sets of chromatic balance coordinates; and
a luminance control unit which controls a luminance of the display portion.

17. The display device according to claim 16,
the luminance control unit switching the luminance in association with switching of the at least two sets of chromatic balance coordinates used in the color control unit.

18. The display device according to claim 16,
the color control unit switching to use a different set of chromatic balance coordinates in association with a luminance obtained by switching in the luminance control unit.

19. The display device according to claim 16,
the at least two sets of chromatic balance coordinates including a first set of chromatic balance coordinates defining white and a second set of chromatic balance coordinates defining one of colors other than white.

20. The display device according to claim 19,
the color control unit using the first set of chromatic balance coordinates when a luminance obtained by switching in the luminance control unit is less than a predetermined threshold value, and using the second set of chromatic balance coordinates when the luminance is greater than the predetermined threshold value.

21. The display device according to claim 19,
the display device having pixels, each pixel including at least two pixel components having different optical spectrum characteristics;
the at least two sets of chromatic balance coordinates defining reference colors for a color displayed on the pixel;
the pixel including a first pixel component that emits a light component having a first peak wavelength, a second pixel component that emits a light component having a second peak wavelength, and a third pixel component that emits a light component having a third peak wavelength; and
the second set of chromatic balance coordinates representing a color obtained by mixing, at a predetermined ratio, the light components emitted by the first, second, third pixel components, and representing a color obtained by mixing the light components emitted by the first, second, third pixel components, with the ratio of the light component of one pixel component set to be greater than the light components of the other pixel components, the one pixel component having the least long-term emission-luminance deterioration among the first, second, third pixel components.

22. The display device according to claim 16, further comprising:
an illumination detecting unit that detects an illumination in the vicinity of the display portion; and
the luminance control unit switching the luminance based on the detected illumination.

23. The display device according to claim 22,
the illumination control unit having a function of setting the luminance to be greater than a target luminance when the illumination is greater than a predetermined reference value, and setting the luminance to be less than the target luminance when the illumination is less than the predetermined reference value.

24. The display device according to claim 16,
the luminance control unit switching the luminance in association with a display form used in the display portion.

25. The display device according to claim 24,
the display form being one of a natural image representation, a representation of an image other than a natural image, an analog representation of the result of measurement, and a digital representation of the result of measurement.

26. The display device according to claim 19,
the color control unit having a function of using the first set of chromatic balance coordinates to control a display color when a natural image is displayed on the display portion, and using the second set of chromatic balance coordinates to control the display color when an image other than the natural image is displayed on the display portion; and
the luminance control unit having a function of setting the luminance to be less than a target value when the natural image is displayed on the display portion, and setting the luminance to be greater than the target value when the image other than the natural image is displayed on the display portion.

27. An on-vehicle display device, having the configuration of the display device as set forth in claim 16 in a form installable in a vehicle.

28. The on-vehicle display device according to claim 27,
the on-vehicle display device being provided on an instrument panel in the vicinity of a driver's seat in the vehicle.

29. An electronic apparatus including the display device as set forth in claim 16.

30. A display method, comprising:
setting at least two sets of chromatic balance coordinates defining reference colors for a display color on a display portion;
switching the at least two sets of chromatic balance coordinates to control a display color on the display portion by using one set of chromatic balance coordinates;
variably controlling a luminance of the display portion; and
controlling the switching of the at least two sets of chromatic balance coordinates and the variably controlling of the luminance so that the switching of the sets of chromatic balance coordinates and the variably controlling of the luminance are associated with each other.

31. The display method according to claim 30,
the at least two sets of chromatic balance coordinates including a first set of chromatic balance coordinates defining white and a second set of chromatic balance coordinates defining one of colors other than white;
when the luminance needs to be less than a predetermined threshold value, the first set of chromatic balance coordinates is used; and
when the luminance needs to be greater than the predetermined threshold value, the second set of chromatic balance coordinates is used.

32. The display method according to claim 31,
an image being displayed by using pixels, each pixel including at least two pixel components having different optical spectrum characteristics; and
the second set of chromatic balance coordinates representing a color obtained by mixing, at a predetermined ratio, light components emitted by the pixel components of the pixel, and represents a color obtained by mixing the light components emitted by the pixel components, with the ratio of the light component of one pixel component set to be greater than the light components of the other pixel components, the one pixel component having the least long-term emission-luminance deterioration among the pixel components.

33. The display method according to claim 30,
an illumination in the vicinity of the display portion being detected; and
the luminance being set to be greater than a target luminance when the illumination is greater than a predetermined reference value, and being set to be less than the target luminance when the illumination is less than the predetermined reference value.

34. The display method according to claim 31,
when the result of measurement by a measuring instrument is displayed, the second set of chromatic balance coordinates is used for display; and
when information other than the result of the measurement is displayed for display, the first set of chromatic balance coordinates is used.
